(19) United States
(12) Patent Application Publication
(10) Pub. No.: US 2015/0099855 A1
(43) Pub. Date: Apr. 9, 2015

(54) GAS PHASE POLYMERISATION OF ETHYLENE

(71) Applicant: Saudi Basic Industries Corporation, RIYADH (SA)

(72) Inventors: Orass Hamed, Riyadh (SA); Abdulmalik Bin-Taleb, Riyadh (SA)

(21) Appl. No.: 14/403,321

(22) PCT Filed: May 25, 2013
(86) PCT No.: PCT/EP2013/060637

§ 371 Date: Nov. 24, 2014

(30) Foreign Application Priority Data
Jun. 14, 2012 (EP) 12075057.5

(51) Int. Cl. C08F 210/16

(52) U.S. Cl. CPC C08F 210/16
USPC 526/113; 526/348.5

(57) ABSTRACT

The present invention is directed to a process for the gas phase polymerisation of ethylene in the presence of a catalyst composition comprising a support material carrying a chromium compound and a magnesium containing compound represented by the formula R¹MgX, wherein R¹ is a (C₁-C₂₀) hydrocarbon group and X is a halogen atom wherein the molar ratio chromium to magnesium ranges between 10:1 and 1:1.

The present invention relates to the gas phase polymerisation of ethylene.

The production processes of LDPE, HDPE and LLDPE are summarised in “Handbook of Polyethylene” by Andrew Peacock (2000; Dekker; ISBN 0824795466) at pages 43-66. The catalysts can be divided in three different subclasses including Ziegler Natta catalysts, Phillips catalysts and single site catalysts. The various processes may be divided into solution polymerisation processes employing homogeneous (soluble) catalysts and processes employing supported (heterogeneous) catalysts. The latter processes include both slurry and gas phase processes.

The chromium oxide based catalyst, which is commonly referred to in the literature as “the Phillips catalyst”, can be obtained by calcining a chromium compound carried on an inorganic oxide carrier in a non-reducing atmosphere. The chromium oxide catalysis and the ethylene polymerisation with this specific catalyst are disclosed in “Handbook of Polyethylene” by Andrew Peacock at pages 61-64.

Pullukat et al. (Journal of Polymer Science; Polymer chemistry Edition; vol 18, 2857-2866; 1980) discloses thermally activated ethylene polymerisation catalysts which contain chromium and titanium on silica.

It is a disadvantage of ethylene polymerisation catalysts which contain chromium and titanium on silica that they cannot be applied in the polymerisation of ethylene in a gas phase reactor process because said catalyst system will run at very low bed temperatures when the object is to obtain polymers with relatively low melt indices for example in the range between 2 and 5 (MI_{21.6 kg}). The temperature drops at this stage to a temperature in the range of 88 and 92 degrees Celsius which results in a very low production rate.

It is the object of the present invention to provide a gas phase process resulting in polyethylene with relatively low melt indices for example in the range between 2 and 5 (MI_{21.6 kg}).

The present invention relates to a process for the gas phase polymerisation of ethylene in the presence of a catalyst composition comprising a support material carrying a chromium compound and a magnesium compound represented by the formula R¹MgX, wherein
R¹ is a (C₁-C₂₀) hydrocarbon group and
X is a halogen atom
   wherein the molar ratio chromium to magnesium ranges between 10:1 and 1:1.

It is an advantage of the present invention that the gas phase polymerization process results in high density polyethylene having the properties to make them processable into pellets which are suitable for blow molding applications like drums and industrial bulk containers of 200 liters and higher.

The process according to the invention results in the possibility to operate at high bed temperatures of for example about 105 degrees Celsius if a high density polyethylene with a relatively low high-load melt index (HLMI) of between for example 3 and 5 is desired.

Suitable support materials include for example inorganic oxides of silica, alumina, silica-alumina mixture, thoria, zirconia and comparable oxides which are porous, have a medium surface area, and have surface hydroxyl groups. Supported chromium catalysts are described for example, in U.S. Pat. No. 2,825,721. The support may be modified so as to include cogels such as for example silica-titania or silica-alumina and by the replacement of silica by alumina or amorphous aluminum phosphates. The silica support may also be doped with chemical compounds containing for example aluminum, titanium, phosphorus, boron or fluorine.

According to a preferred embodiment of the invention the support material is a silica support material.

Preferably the silica has a surface area (SA) ranging between 300 m²/g and 500 m²/g, a pore volume (PV) between 1.0 cm³/g and 2.0 cm³/g and a particle size between 30 and 90 micrometres.

Examples of very suitable silica include silica having a surface area (SA) of 650 m² /g, a pore volume (PV) of 1.9 cm³/g and a particle size of 25 micrometres and silica having a surface area (SA) of 700 m²/g, a pore volume (PV) of 1.8 cm³/g and a particle size of 35 micrometres.

The selection of the support is important in increasing the molecular weight of the produced polymer maintaining superior morphology, high resin bulk density and minimum level of fines.

The chromium compound can be selected from various organic and inorganic forms of chromium.

Preferably the chromium compound is selected from chromium acetate, chromium acetyl acetonate, chromium acetate hydroxide and chromium trioxide.

According to a further preferred embodiment of the invention the catalyst composition comprises a porous inorganic support material carrying a chromium salt, a magnesium containing compound and a transition metal containing compound or metal halide transition metal compound.

In the catalyst composition the chromium compound which is activated in the calciner to turn into CrO₃ “active sites” for ethylene polymerization is the precursor. The catalyst composition comprises besides the CrO₃ compound on silica a magnesium compound and optionally a metal compound supported on silica.

According to a preferred embodiment of the invention the transition metal compound or metal halide transition metal compound has the formula Tₘ(OR¹)ₙX₄₋ₙ and Tₘ(R²)ₙX₄₋ₙ, wherein
Tₘ represents a transition metal of Group IVB, VB, or VIB,
R¹ and R² represent an (C₁-C₂₀) alkyl group, (C₁-C₂₀) aryl group or (C₁-C₂₀) cycloalkyl group,
X represents a halogen atom and
n represents a number satisfying 0≧n≦4.

The transition metal may be titanium, vanadium, hafnium or zirconium.

According to a preferred embodiment of the invention the metal is titanium.

Suitable examples of R¹ include (C₁-C₂₀) alkyl groups for example methyl, ethyl, n-propyl, isopropyl and n-butyl groups.

Preferably the halogen atom is chlorine.

Preferably the transition metal compound or metal halide transition metal compound has the formula Tₘ (OR¹)ₙX₄₋ₙ

Examples of suitable titanium compounds having the general formula Tₘ(OR¹)ₙX₄₋ₙ and Tₘ(R²)ₙX₄₋ₙ include titanium alkoxy compounds for example tetraethoxy titanium, tetramethoxy titanium, tetrabutoxy titanium, tetrapropoxy titanium, tetraisobutoxy titanium, tetrapentoxy titanium, triethoxychloro titanium, diethoxydichloro titanium , trichloethoxy titanium, methoxy titanium trichloride, dimethoxy titanium dichloride, ethoxy titanium trichloride, diethoxy titanium dichloride, propoxy titanium trichloride, dipropoxy titanium dichloride, butoxy titanium trichloride, butoxy titanium dichloride, titanium tetrachloride, vanadium trichloride, vanadium tetrachloride, vanadium oxytrichloride, zirconium tetrachloride and/or vanadium tetrachloride.

According to a preferred embodiment of the invention the magnesium containing compound is a Grignard compound represented by the formula R¹MgX, wherein
R¹ is a (C₁-C₂₀) hydrocarbon group and
X is a halogen atom.
   Preferably the halogen atom is chlorine.

According to a further preferred embodiment of the invention the magnesium compound is represented by the formula R²R³Mg, wherein R² and R³ are the same or different (C₁-C₂₀) hydrocarbon groups.

When the catalyst is activated in air inside the calciner, at 600-800° C. all the magnesium will turn into magnesium oxide.

Suitable examples of the above identified magnesium compounds include dialkylmagnesium compounds for example diethylmagnesium, dipropylmagnesium, di-iso-proylmagnesium, di-n-butylmagnesium, di-iso-butylmagnesium butylethylmagnesium, dihexylmagnesium, dioctylmagnesium; alkyl magnesium chloride such as ethylmagnesium chloride, butylmagnesium chloride and/or hexylmagnesium chloride.

It is possible to use an organoaluminium compound to further improve the product quality by broadening its MWD. The organoaluminum compound may have the general formula R¹ₙAlX₃, wherein R¹ represent an alkyl group having from 1 to 10 carbon atoms, X represents halogen atom and 1≦n≦3.

Suitable examples of the organoaluminum compound include for example trimethylaluminum, triethylaluminum, triisobutylaluminum, tri-n-hexylaluminum, ethylaluminum dichloride, ethylaluminum sesquichloride and/or diethylaluminum chloride. Preferably triisobutylaluminum and/or diethylaluminum chloride are applied.

The molar ratio of chromium to aluminium, meaning the moles of chromium divided by the moles of aluminium may range between 1:0.1 and 1:1.

The chromium oxide based catalyst composition contains a silica support.

Preferably the molar ratio chromium to magnesium ranges between 2:1 and 1:1.

Preferably the molar ratio chromium to transition metal ranges between 1:10 and 1:1.

Preferably the molar ratio chromium to transition metal ranges between 1:15 and 1:5.

Preferred metal loadings are for chromium between 0.3 and 0.7%, for titanium between 2 and 5% and for magnesium between 0.05 and 0.5%.

The polymerisation takes place via a gas phase polymerisation process. A gas phase reactor is essentially a fluidized bed of dry polymer particles maintained either by stirring or by passing gas (ethylene) at high speeds through it. The obtained powder is mixed with stabilizers and generally extruded into pellets. Gas fluidized bed polymerisation processes are summarised by Than Chee Mun in Hydrocarbons 2003 “Production of polyethylene using gas fluidised bed reactor”. Gas phase polymerisation generally involves adding gaseous monomers into a vertically oriented polymerisation reactor filled with previously formed polymer, catalyst particles and additives. Generally the polymerisation in the gas phase polymerisation systems takes place at temperatures between 30° C. and 130° C. with super atmospheric pressures. The rising gas phase fluidizes the bed, and the monomers contained in the gas phase polymerize onto supported catalyst or preformed polymer during this process. Upon reaching the top of the reactor, unreacted monomer is recycled, while polymer continually falls down along the sides of the reactor. Examples of suitable gas phase polymerisations are disclosed in for example U.S. Pat. No. 4,003,712 and US-A-20050137364.

In the case of the production of an ethylene copolymer the alpha olefin co monomer may be propylene, 1-butene, 1-pentene, 4-methyl-1-pentene, 1-hexene and/or 1-octene.

The catalyst composition comprising silica as a porous inorganic support material carrying a chromium salt and a magnesium containing compound may be prepared by adding the chromium salt to the silica support in a suitable solvent like methanol or ethanol then the slurry is mixed and dried at about for example 85° C. That is followed by adding and mixing the magnesium compound in an isopentane solvent followed by a drying step at about for example 75° C. Next the dry catalyst mixture is activated in the calciner in air at temperatures ranging between 500-800° C. for at least 4 hours.

The catalyst composition comprising additionally the transition metal compound may be prepared by adding the chromium salt to the silica support in a suitable solvent like methanol or ethanol then the slurry is mixed and dried for example at about 85° C. That is followed by the addition of the transition metal compound in isopentane solvent to be mixed and finally adding the magnesium compound in the same isopentane medium then mixed and dried for example at about 75° C. Next the dry catalyst mixture is activated in the calciner in air at temperatures ranging between 500-800° C. for at least 4 hours.

The polyethylene powder obtained with the catalyst composition according to the present invention has:
a high-load melt index (HLMI) ≧1 g/10 min and 55 g/10 min (according to ISO 1133)
M_{w}/Mₙ ≧5 and ≦100 (according to size exclusion chromatography (SEC) measurement)
a density ≧945 kg/m³ and ≦958 kg/m³ (according to ISO 1183).

According to a preferred embodiment of the invention the density ranges between ≧945 kg/m³ and ≦954 kg/m³

According to a preferred embodiment of the invention the high-load melt index (HLMI) ranges between ≧2 g/10 min and ≦5 g/10 min (according to ISO 1133).

The ethylene polymers obtained with the process according to the invention may be combined with additives such as for example lubricants, fillers, stabilisers, antioxidants, compatibilizers and pigments. The additives used to stabilize the polymers may be, for example, additive packages including hindered phenols, phosphites, UV stabilisers, antistatics and stearates.

The ethylene polymers may be extruded or blow-moulded into articles such as for example containers, fuel tanks and drums. The polymers may also be suitable to be applied in specific film and pipe applications.

HDPE is used to manufacture different types of industrial transit packaging such as large industrial open head drums, tight head drums, jerry cans, fuel tanks and intermediate bulk containers (IBC). The different types of storage and transit containers require different types of HDPE as the basic polymer because each type of industrial storage container requires an unique balance of impact resistance and ESCR properties and good processability properties. In the development and the selection of the polymer there is typically a trade-off between characteristics such as resistance to slow crack growth (measured for example by ESCR), stiffness (measured for example by density) impact resistance (measured for example by Izod), chemical resistance and processability or more specifically ease of extrusion (measured for example by melt index). Typically the higher the molecular weight of polyethylene the higher the impact resistance and ESCR. However, increasing the molecular weight will decrease processability and make extrusion more difficult. The end user and the governmental regulations require that the container meet certain minimum requirements, such as for example for impact resistance, top load, ESCR, chemical resistance, food approval and UN approval. Furthermore the producer of the containers expects ease of processability and material consistency. Depending on the end use, there may be even more specific requirements of the material. For instance, in the case of large drums and IBC manufactured by blow moulding, a high melt strength is generally desired, as the parison produced in the blow moulding process typically must maintain its integrity for longer periods of time as the object made gets larger. Each blow moulding application requires specific properties of the HDPE grades. For example, for food packaging organoleptic properties are important whereas environmental stress crack resistance and stiffness are important for detergent and cleaner applications. Industrial containers require chemical resistance and impact strength, especially when the containers are filled with products classified as dangerous goods. Plastic blow moulded IBC's or composite IBC's are multi-purpose, used both to transport and store products. They are widely used to transport liquids and viscous products, but also for pastes and powders.

The focus for polymer development within this IBC market is to obtain an excellent processability and down gauging while maintaining a good balance in impact and ESCR properties.

The invention will be elucidated by means of the following non-limiting examples.

### EXAMPLES

The properties of the polymers produced in the Examples were determined as follows:

The polymer density (kg/m³) was determined as specified in ASTM D 1505-68. Polymer molecular weight and its distribution (MWD) were determined by Polymer Labs 220 gel permeation chromatograph. The chromatograms were run at 150° C. using 1,2,4-trichlorobenzene as the solvent with a flow rate of 0.9 ml/min. The refractive index detector is used to collect the signal for molecular weights. The software used is Cirrus from PolyLab for molecular weights from Gel Permeation Chromatography (GPC). The calibration of the HT-GPC uses a Hamielec type calibration with broad standard and fresh calibration with each sample set.

### Example I

### Synthesis of Catalyst Composition According to the Invention

To a three-necked round bottom flask, equipped with a condenser and a mechanical stirrer 30 g of dried silica having a surface area (SA) of 650 m²/g, a pore volume (PV) of 1.9 cm³/g and a particle size of 25 micrometres at 200° C. is placed into the flask then 0.55 g of Chromium acetate hydroxide were added to the silica then slurried in 250 cm³ of ethyl alcohol (100%), which was stirred at 70° C. for 60 minutes. After wards drying ethanol solvent took place at 85° C. with nitrogen purge. The dried chrome on silica powder was cooled down to room temperature then slurried with 250 cm³ of iso-pentane, to be followed by the addition of 7 cm³ of tetra ethoxy titanium Ti(OC₂H₅)₄ (100%). The contents were mixed at 35° C. for another 60 minutes followed by the addition of 0.5 cm³ of 2M BuMgCl which was allowed to mix for 30 minutes at 35° C. then drying the solvent at 75° C. with nitrogen purge. For the chrome catalyst activation the dried catalyst powder was placed in the calciner and the following sequence was followed:
Ramp from ambient to 150° C. in 3 hours under N2 flow then hold for 10 minutes
Ramp from 150° C. to 450° C. in 3 hours
At 450° C. switch from N₂ to O₂ flow
Ramp from 450° C. to 750° C. in 3 hours under O₂
Hold at 750° C. for 3 hours
Cool to room temperature then switch to N2 purge.

Elemental analysis: 0.34 wt % Cr, 3.2 wt % Ti and 0.07 wt % Mg

### Example II

### Ethylene Polymerization

An autoclave with a volume of 2 liters was purged with nitrogen at 130° C. for 30 minutes. After cooling the autoclave to 70° C., one liter of iso-pentane and 10 ml of 1-hexene were introduced to the reactor, then the reactor was pressurized with 15 bar ethylene.

Then 0.1 mmol of triethylaluminum (TEAL) was injected into the reactor by the means of a catalyst injection pump.

This was followed by injection of 0.15 g of catalyst composition according to Example I after being slurried in 20 cm³ of Iso-pentane solvent. The reactor temperature was raised to 105° C. Ethylene polymerization was carried out for 60 minutes; with ethylene supplied on demand to maintain the total reactor pressure at 20 bar. 300 litres of ethylene were consumed and 280 grams of polyethylene was recovered giving a catalyst productivity of 1,800 g PE/g cat h at 200 psig.

The characteristics of the obtained polyethylene:
weight average molecular weight: 451,272,
number average molecular weight: 11,602
molecular weight distribution: 39
HLMI=3.2
density: 949 kg/m³
bulk density: 333 kg/m³.
fines level was measured at 0.5%.

### Comparative Example A

### Synthesis of Catalyst Composition without Magnesium

To a three-necked round bottom flask, equipped with a condenser and a mechanical stirrer 30 g of dried silica having a surface area (SA) of 650 m²/g, a pore volume (PV) of 1.9 cm³/g and a particle size of 25 micrometres at 200° C. is placed into the flask then 0.57 g of Chromium acetate hydroxide were added to the silica then slurried in 250 cm³ of ethyl alcohol (100%), which was stirred at 70° C. for 60 minutes. After wards drying ethanol solvent took place at 85° C. with nitrogen purge. The dried chrome on silica powder was cooled down to room temperature then slurried with 250 cm³ of iso-pentane, to be followed by the addition of 7 cm³ of tetraethoxy titanium Ti(OC₂H₅)₄ (100%). The contents were mixed at 35° C. for another 60minutes followed by drying the IC5 solvent at 75° C. with nitrogen purge.

For the chrome catalyst activation the dried catalyst powder was placed in the calciner and the following sequence was followed:
Ramp from ambient to 150° C. in 3 hours under N2 flow then hold for 10 minutes
Ramp from 150° C. to 450° C. in 3 hours
At 450° C. switch from N₂ to O₂ flow
Ramp from 450° C. to 750° C. in 3 hours under O₂
Hold at 750° C. for 3 hours
Cool to room temperature then switch to N₂ purge.

Elemental analysis: 0.38 wt % Cr and 3.2 wt % Ti

### Comparative Example B

### Ethylene Polymerization

An autoclave with a volume of 2 litres was purged with nitrogen at 130° C. for 30 minutes. After cooling the autoclave to 70° C., one litre of iso-pentane and 10 ml of 1-hexene, was introduced to the reactor, then the reactor was pressurized with 15 bar ethylene. Then 0.1 mmol of TEAL was injected into the reactor by the means of a catalyst injection pump.

This was followed by injection of 0.15 g of catalyst composition according to Comparative Example A after being slurried in 20 cm³ of iso-pentane solvent. The reactor temperature was raised to 101° C. Ethylene polymerization was carried out for 60 minutes; with ethylene supplied on demand to maintain the total reactor pressure at 20 bar. 317 litre of ethylene were consumed and 280 grams of polyethylene was recovered giving a catalyst productivity of 1,866 g PE/g cat h at 200 psig.

The characteristics of the obtained polyethylene:
weight average molecular weight: 315,519
number average molecular weight: 10,996
molecular weight distribution: 28
HLMI: 6
density: 952 kg/m³.
bulk density: 331 kg/m³.
fines level was measured at 1.1%.

### Example III

### Synthesis of catalyst composition according to the invention

To a three-necked round bottom flask, equipped with a condenser and a mechanical stirrer 30 g of dried silica having a surface area (SA) of 700 m²/g, a pore volume (PV) of 1.8 cm³/g and a particle size of 35 micrometres at 200° C. is placed into the flask then 0.57 g of chromium acetate hydroxide were added to the silica then slurried in 250 cm³ of Methanol (100%), which was stirred at 70° C. for 60 minutes. After wards drying ethanol solvent took place at 85° C. with nitrogen purge. The dried chrome on silica powder was cooled down to room temperature then slurried with 250 cm³ of iso-pentane, to be followed by the addition of 1.5 cm³ of 2M BuMgCl which was allowed to mix for 30 minutes at 45° C. then drying the solvent at 75° C. with nitrogen purge. For the chrome catalyst activation the dried catalyst powder was placed in the calciner and the following sequence was followed:
Ramp from ambient to 150° C. in 3 hours under N2 flow then hold for 10 minutes
Ramp from 150° C. to 450° C. in 3 hours
At 450° C. switch from N₂ to O₂ flow
Ramp from 450° C. to 750° C. in 3 hours under O₂
Hold at 750° C. for 3 hours P1 Cool to room temperature then switch to N2 purge.

Elemental analysis: 0.35 wt % Cr and 0.25 wt % Mg

### Example IV

### Ethylene Polymerization

An autoclave with a volume of 2 liters was purged with nitrogen at 130° C. for 30 minutes. After cooling the autoclave to 70° C., one liter of iso-pentane and 10 ml of 1-hexene were introduced to the reactor, then the reactor was pressurized with 15 bar ethylene. Then 0.1 mmol of TEAL was injected into the reactor by the means of a catalyst injection pump. This was followed by injection of 0.15 g of catalyst composition according to the above Example after being slurried in 20 cm³ of Iso-pentane solvent. The reactor temperature was raised to 107° C. Ethylene polymerization was carried out for 60 minutes; with ethylene supplied on demand to maintain the total reactor pressure at 20 bar. 340 litres of ethylene were consumed and 297 grams of polyethylene was recovered giving a catalyst productivity of 1,980 g PE/g cat h at 200 psig.

The characteristics of the obtained polyethylene:
weight average molecular weight: 527,272,
number average molecular weight: 19,602
molecular weight distribution: 27
HLMI=2.2
density: 950 kg/m³
bulk density: 403 kg/m³.
fines level was measured at 0.12%.

1. A process for the gas phase polymerisation of ethylene in the presence of a catalyst composition comprising a support material carrying a chromium compound and a magnesium containing compound represented by the formula R¹MgX, wherein
R¹ is a (C₁-C₂₀) hydrocarbon group and
X is a halogen atom
wherein the molar ratio of chromium to magnesium ranges between 10:1 and 1:1.

2. A process according to claim 1 wherein the support material is silica.

3. A process according to claim 2 wherein the silica has a surface area (SA) ranging between 300 m²/g and 500 m²/g, a pore volume (PV) between 1.0 cm³/g and 2.0 cm³/g, and a particle size between 30 and 90 micrometres.

4. A process according to claim 1 wherein the catalyst comprises a transition metal containing compound or a metal halide transition metal compound.

5. A process according to claim 4 wherein the molar ratio of chromium to transition metal ranges between 1:20 and 1:1 and wherein the molar ratio of magnesium to transition metal ranges between 1:20 and 1:1.

6. A process according to claim 1 wherein the magnesium compound is a compound of the formula R²R³Mg, wherein R² and R³ are the same or different (C₁-C₂₀) hydrocarbon groups.

7. A process according to claim 2 wherein the transition metal containing compound or metal halide transition metal compound has the general formula Tₘ(OR¹)ₙX₄₋ₙ and Tₘ(R²)ₙX₄₋ₙ, wherein
Tₘ represents a transition metal of Group IVB, VB, or VIB,
R¹ and R² represent an (C₁-C₂₀) alkyl group, (C₁-C₂₀) aryl group or (C₁-C₂₀) cycloalkyl group,
X represents a halogen atom, and
n represents a number satisfying 0≧n≦4.

8. A process according to claim 7 wherein the metal is titanium, vanadium, hafnium, or zirconium.

9. A process according to claim 8 wherein the metal is titanium.

10. A high density polyethylene having
a high-load melt index (HLMI) ≧1 g/10 min and <5 g/10 min (according to ISO 1133),
Mw/Mn ≧5 and ≦100 (according to size exclusion chromatography (SEC) measurement), and
a density ≧945 kg/m3 and ≦958 kg/m3 (according to ISO 1183.

11. An article comprising the gas phase polymerisation product of claim 1.

12. An industrial bulk container comprising the gas phase polymerisation product of claim 1.

13. An article comprising the gas phase polymerisation product of claim 10.

14. An article comprising the gas phase polymerisation product of claim 10.
